(19) United States
(12) Patent Application Publication
(10) Pub. No.: US 2026/0181676 A1
(43) Pub. Date: Jun. 25, 2026

(54) COORDINATED CHANNEL ADVERTISEMENT

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Frisco, TX (US); Yue Qi, Plano, TX (US); Bilal Sadiq, Plano, TX (US)

(21) Appl. No.: 19/411,151

(22) Filed: Dec. 5, 2025

Related U.S. Application Data
(60) Provisional application No. 63/738,349, filed on Dec. 23, 2024.
(60) Provisional application No. 63/753,217, filed on Feb. 3, 2025.

(51) Int. Cl. H04W 72/27; H04W 28/18; H04W 84/12

(52) U.S. Cl. CPC H04W 72/27; H04W 28/18; H04W 84/12

(57) ABSTRACT

Methods and apparatuses for coordinated channel advertisement. A method of wireless communication performed by a first access point (AP) includes performing a coordinated channel recommendation (CO-CR) procedure with a second AP for coordination to decide a set of common channels to facilitate peer-to-peer (P2P) communication on the set of common channels.

### CROSS-REFERENCE TO RELATED APPLICATION(S) AND CLAIM OF PRIORITY

This application claims priority under 35 U.S.C. § 119(e) to U.S. Provisional Ser. No. 63/738,349, filed on Dec. 23, 2024, and U.S. Provisional Ser. No. 63/753,217, filed on Feb. 3, 2025, which are hereby incorporated by reference in their entirety.

### TECHNICAL FIELD

This disclosure relates generally to wireless communication, and more specifically to coordinated channel advertisement.

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for coordinated channel advertisement.

In one embodiment, a first access point (AP) comprises: a transceiver; and a processor operably coupled to the transceiver. The processor is configured to: perform a coordinated channel recommendation (CO-CR) procedure with a second AP for coordination to decide a set of common channels to facilitate peer-to-peer (P2P) communication on the set of common channels.

In another embodiment, a method performed by a first AP comprises: performing a CO-CR procedure with a second AP for coordination to decide a set of common channels to facilitate P2P communication on the set of common channels.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example access point (AP) according to embodiments of the present disclosure;

FIG. 3 illustrates an example station (STA) according to embodiments of the present disclosure;

FIG. 4 illustrates an example of a network where infrastructure traffic and non-infrastructure traffic coexist according to embodiments of the present disclosure;

FIG. 5 illustrates an example method performed by an initiating access point (AP) according to embodiments of the present disclosure;

FIG. 6 illustrates an example method performed by a responding AP according to embodiments of the present disclosure;

FIG. 7 illustrates an example of a STA indicating unavailability for frame exchange with an associated AP due to scheduled peer-to-peer (P2P) communication with another STA according to embodiments of the present disclosure;

FIG. 8 illustrates an example of a STA indicating unavailability for frame exchange with an associated AP due to a scheduled coexistence event with another STA according to embodiments of the present disclosure;

FIG. 9 illustrates an example where a STA has set up an unavailability schedule or a P2P target wake time (TWT) schedule with its associated AP according to embodiments of the present disclosure;

FIG. 10 illustrates an example of link indication for unavailability schedule establishment where the response frame does not contain the link information according to embodiments of the present disclosure;

FIG. 11 illustrates an example of link indication for unavailability schedule establishment where the response frame contains the link information according to embodiments of the present disclosure;

FIG. 12 illustrates an example of an AP MLD suggesting an alternative link for establishing the P2P TWT schedule according to embodiments of the present disclosure;

FIG. 13 illustrates an example of a non-AP MLD indicating an availability link for communication during the P2P TWT on another link according to embodiments of the present disclosure;

FIG. 14 illustrates an AP MLD suggesting an availability link in the response frame according to embodiments of the present disclosure; and

FIG. 15 illustrates an example method performed by an AP in a wireless communication system according to embodiments of the present disclosure.

### DETAILED DESCRIPTION

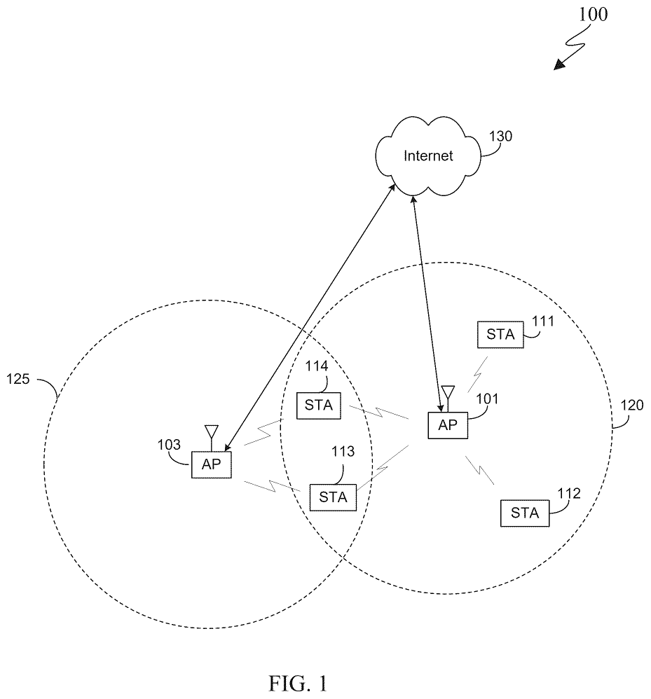

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D6.0, “Part 11: Wireless LAN Medium Access Control (MAC) and Physical Layer (PHY) Specifications—Amendment 8: Enhancements for extremely high throughput (EHT)”; [2] IEEE P802.11 REVme Draft D6.0 “Part 11: Wireless LAN Medium Access Control (MAC) and Physical Layer (PHY) Specifications”; [3] IEEE P802.11be/D3.0, “Part 11: Wireless LAN Medium Access Control (MAC) and Physical Layer (PHY) Specifications—Amendment 8: Enhancements for extremely high throughput (EHT)”; [2] IEEE P802.11 REVme Draft D2.1 “Part 11: Wireless LAN Medium Access Control (MAC) and Physical Layer (PHY) Specifications”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating coordinated channel advertisement. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

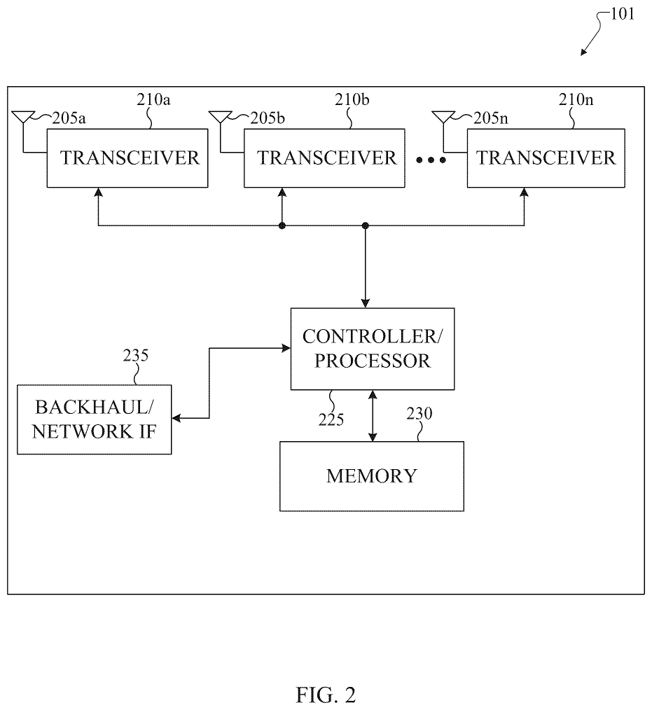

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating coordinated channel advertisement. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating coordinated channel advertisement. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted, and additional components could be added according to particular needs.

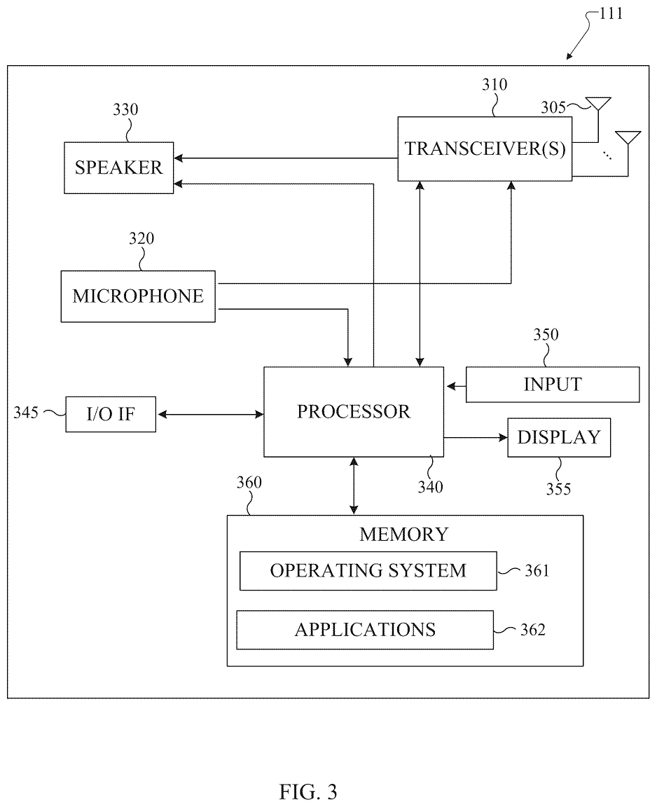

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate coordinated channel advertisement. In some embodiments, the processor 340 includes at least one microprocessor or microcontroller.

The processor 340 is also capable of executing other processes and programs resident in the memory 360, such as operations for facilitating coordinated channel advertisement. The processor 340 can move data into or out of the memory 360 as required by an executing process. In some embodiments, the processor 340 is configured to execute a plurality of applications 362, such as applications for facilitating coordinated channel advertisement. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

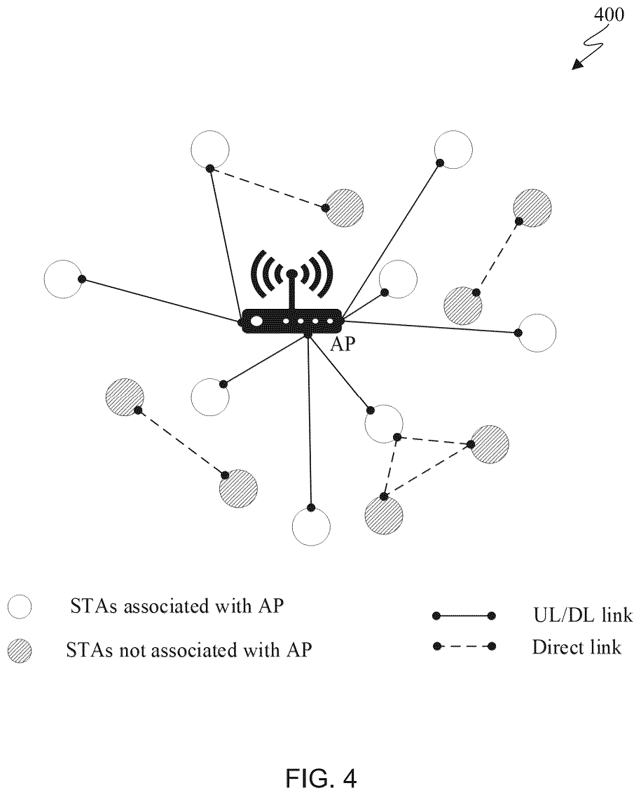

FIG. 4 illustrates an example of a network 400 where infrastructure traffic and non-infrastructure traffic coexist according to embodiments of the present disclosure. The embodiment of the network 400 where infrastructure traffic and non-infrastructure traffic coexist shown in FIG. 4 is for illustration only. Other embodiments of the network 400 where infrastructure traffic and non-infrastructure traffic coexist could be used without departing from the scope of this disclosure.

Embodiments of the present disclosure recognize that next a generation WLAN system needs to provide better support for low-latency applications. Today it is not uncommon to observe numerous devices operating on the same network. Many of such devices may be latency-tolerant but still contend with the devices with low-latency applications for the same time and frequency resources. In some cases, the access point (AP) as the network controller may not have enough control over the unregulated/unmanaged traffic that contend with the low-latency traffic within the infrastructure BSS. Some of the unmanaged traffic that interfere with the AP's BSS′ latency sensitive traffic may be coming from uplink (UL)/downlink (DL) or direct link communications within the infrastructure BSS that the AP manages; others may be due to transmission in the neighboring infrastructure BSS (OBSS); yet others may be coming from neighboring independent BSS or P2P networks. FIG. 4 illustrates this kind of network. The next generation WLAN system needs mechanisms to better handle the unmanaged traffic in order to prioritize the low-latency traffic in the network.

In the IEEE 802.11be specification, the SCS procedure was enhanced, and a new element, the QoS characteristics element, was introduced, which can be included in the SCS Request and SCS Response frames. The non-AP STA sends to the AP the SCS with the QoS Characteristics element, where the non-AP STA indicates its traffic flow characteristics. The AP reviews the SCS request received from the non-AP STA and, upon acceptance, provisions resources to the non-AP STA based on the traffic characteristics described in the QoS Characteristics element included in the SCS request.

Embodiments of the present disclosure recognize that two non-AP STAs participating in P2P communication must first select a channel for their P2P communication. This P2P channel is often chosen such that there are fewer activities from the infrastructure network (controlled by the AP) on the selected channel. Most often, this channel selection process is heuristics-based; if the two P2P STAs select a random channel for their P2P communication, there is no guarantee from the AP that the AP will reduce its activities on the channel selected by the P2P STAs for their P2P communication.

A first AP can advertise a first channel in its BSS and indicate that this advertised channel would be conducive for P2P communication. However, a second AP in its own BSS can actively use the first channel; therefore, in the first channel, there can still be a significant amount of OBSS interference from the second AP's BSS. Therefore, the recommendation from the first AP on the P2P channel might not be of much use since there can still be a significant amount of OBSS interference from the neighboring APs and their controlled non-AP STA. This problem seriously hampers P2P communication on the channel recommended by an AP.

Accordingly, embodiments of the present disclosure provide mechanisms and protocols so that two P2P STAs can use a recommended channel for P2P communication with reduced OBSS interference.

According to one embodiment, a first AP can coordinate with a second AP such that both the first AP and the second AP can advertise a common channel in their respective BSSs and announce that the selected common channel is conducive for P2P communications. For example, upon coordination, both the first AP and the second AP can decide to advertise channel 6 to be conducive for P2P communication. Such coordination between multiple APs in order to come up with a common channel and declare that common channel to be conducive for P2P communication can be referred coordinated channel advertisement (C-CA).
In reference to the previous embodiment, according to one embodiment, in order to advertise the common channel for P2P communication, an AP can include the common channel information in the Beacon frame or Probe Response frame or Association Response frames that the AP transmits in its BSS.
According to one embodiment, in order to advertise the common channel for P2P communication, an AP can include the common channel information in a Channel Usage element and include the Channel Usage element in the Beacon frame or Probe Response frame or Association Response frames that the AP transmits in its BSS. The included channel usage element can include the information on the common channel.

For the scenario where a first AP intends to participate in multi-AP (MAP) coordination with a second AP in order to devise a channel that both APs declare to be conducive for P2P communication, the first AP can send a first message to the second AP
The first message may contain information indicating that the first message is for negotiating between the first AP and the second AP a common channel for advertisement in both APs BSS and indicate in the advertisement that that common channel is conducive for P2P communications.
The first message may contain information indicating parameters for the common channel; such information may include the proposed channel number, channel band, bandwidth, country code, transmit power information, etc.
According to one embodiment, upon receiving a first message from the first AP, where the first message is for negotiating between the first AP and the second AP a common channel for advertisement in both APs'BSS and indicate in the advertisement that that common channel is conducive for P2P communications, the second AP can send a second message to the first AP indicating whether the second AP agrees to all the parameters suggested by the first AP indicating the channel information that the first AP suggests that both of the APs declare to be conducive for P2P communication.
In reference to the previous embodiment, if the second AP agrees to the parameters of the channel suggested by the first AP, then the second AP can indicate in the second message that the second AP has accepted the parameters. For example, the second message transmitted by the second AP may contain a field indicating the decision of the second AP in reference to the first message received from the first AP. Such a field can be referred to as a Request Type field.
In reference to the previous embodiment, in the first message sent by the first AP, the Request Type field can be set as SUGGEST. A value 0 in the Request Type field, for example, can indicate a suggestion of channel parameters.
In reference to the previous embodiment, in the second message sent by the second AP, if the second AP accepts the channel parameters suggested by the first AP in the first message, then the second AP can indicate the acceptance by setting the Request Type field ACCEPT. A value 1 in the Request Type field, for example, can indicate an acceptance of channel parameters.
In reference to the previous embodiment, in the second message sent by the second AP, if the second AP rejects the channel parameters suggested by the first AP in the first message, then the second AP can indicate the rejection by setting the Request Type field REJECT. A value 2 in the Request Type field, for example, can indicate a rejection of channel

parameters.
In reference to the previous embodiment, in the second message sent by the second AP, if the second AP suggests an alternative set of the channel parameters, then those suggested by the first AP in the first message, then the second AP can indicate the alternative suggestion by setting the Request Type field ALTERNATE. A value of 3 in the Request Type field, for example, can indicate an alternative suggestion of channel parameters.

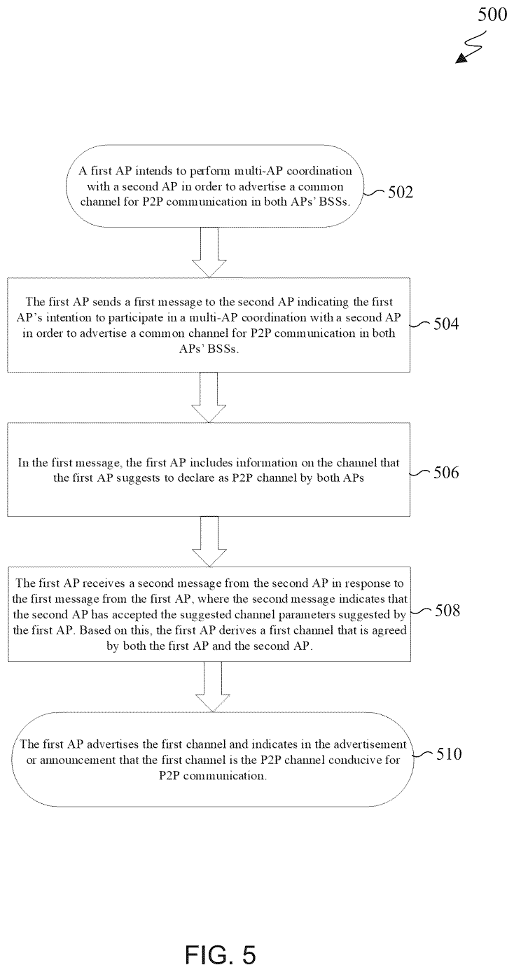

FIG. 5 illustrates an example method 500 performed by an initiating access point (AP) according to embodiments of the present disclosure. The embodiment of the method 500 shown in FIG. 5 is for illustration only. Other embodiments of the method 500 could be used without departing from the scope of this disclosure.

As illustrated in FIG. 5, the method 500 begins at step 502, where a first AP intends to perform multi-AP coordination with a second AP in order to advertise a common channel for P2P communication in both APs'BSSs. At step 504, the first AP sends a first message to the second AP indicating the first AP's intention to participate in a multi-AP coordination with a second AP in order to advertise a common channel for P2P communication in both APs'BSSs. At step 506, in the first message, the first AP includes information on the channel that the first AP suggests to declare as the P2P channel by both APs. At step 508, the first AP receives a second message from the second AP in response to the first message from the first AP, where the second message indicates that the second AP has accepted the suggested channel parameters suggested by the first AP. Based on this, the first AP delivers a first channel that is agreed to by both the first AP and the second AP. At step 510, the first AP advertises the first channel and indicates in the advertisement or announcement that the first channel is the P2P channel conducive for P2P communication.

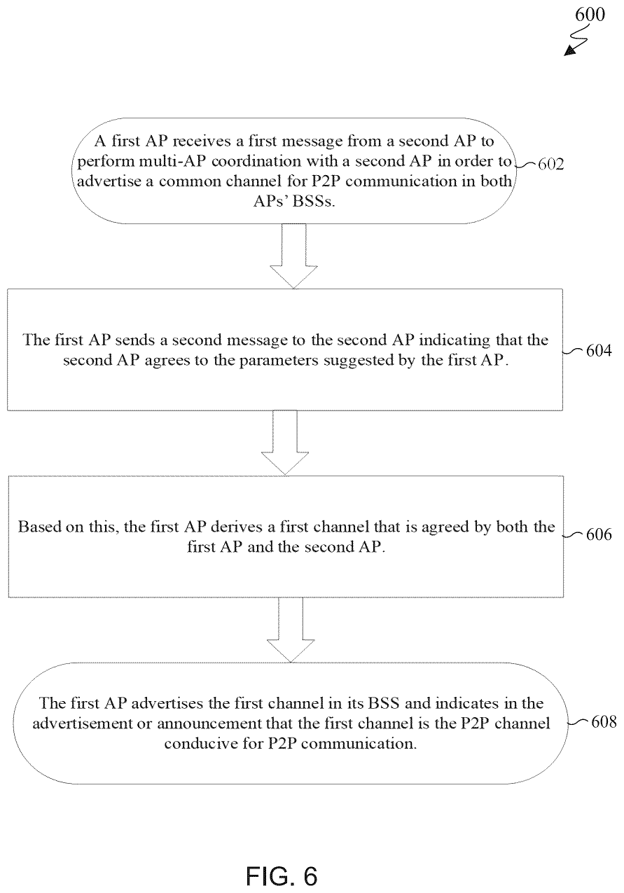

FIG. 6 illustrates an example method 600 performed by a responding AP according to embodiments of the present disclosure. The embodiment of the method 600 shown in FIG. 6 is for illustration only. Other embodiments of the method 600 could be used without departing from the scope of this disclosure.

As illustrated in FIG. 6, the method 600 begins at step 602, where a first AP receives a first message from a second AP in order to perform multi-AP coordination with the second AP in order to advertise a common channel for P2P communication in both APs'BSSs. At step 604, the first AP sends a second message to the second AP indicating that the second AP agrees to parameters suggested by the first AP. At step 606, based on this, the first AP derives a first channel that is agreed to by both the first AP and the second AP. At step 608, the first AP advertises the first channel in its BSS and indicates in the advertisement or announcement that the first channel is the P2P channel conducive for P2P communication.

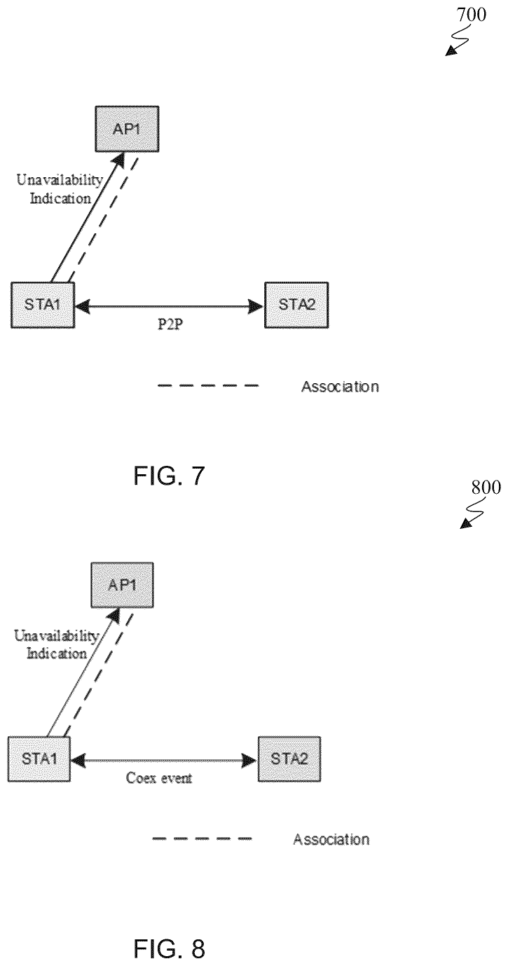

FIG. 7 illustrates an example of a STA indicating unavailability for frame exchange with an associated AP due to scheduled P2P communication with another STA 700 according to embodiments of the present disclosure. The embodiment of the STA indicating unavailability for frame exchange with an associated AP due to scheduled P2P communication with another STA 700 shown in FIG. 7 is for illustration only. Other embodiments of the STA indicating unavailability for frame exchange with an associated AP due to scheduled P2P communication with another STA 700 could be used without departing from the scope of this disclosure.

FIG. 8 illustrates an example of a STA indicating unavailability for frame exchange with an associated AP due to a scheduled coexistence event with another STA 800 according to embodiments of the present disclosure. The embodiment of the STA indicating unavailability for frame exchange with an associated AP due to a scheduled coexistence event with another STA 800 shown in FIG. 8 is for illustration only. Other embodiments of the STA indicating unavailability for frame exchange with an associated AP due to a scheduled coexistence event with another STA 800 could be used without departing from the scope of this disclosure.

According to [2], a first STA can indicate to its associated AP a sequence of time periods during which the first STA will be unavailable for frame exchanges with the AP. During the unavailability with the AP, the first STA may be involved in P2P communication with a second STA. This is shown in FIG. 7. Alternatively, the first STA may also be unavailable due to a scheduled coexistence (coex) event, for example, with STA2. This is illustrated in FIG. 8.

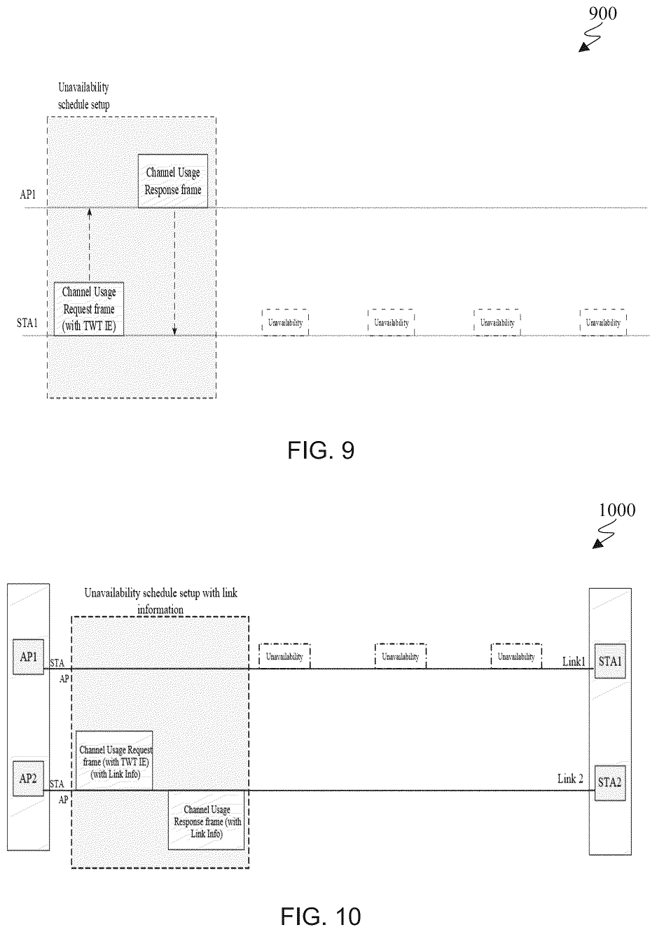

FIG. 9 illustrates an example where a STA has set up an unavailability schedule or a P2P TWT schedule with its associated AP 900 according to embodiments of the present disclosure. The embodiment where a STA has set up an unavailability schedule or a P2P TWT schedule with its associated AP 900 shown in FIG. 9 is for illustration only. Other embodiments where a STA has set up an unavailability schedule or a P2P TWT schedule with its associated AP 900 could be used without departing from the scope of this disclosure.

Embodiments of the present disclosure recognize that for the scenario where a first STA has set up an unavailability schedule or Peer-to-peer TWT schedule with its associated AP, the first STA does not have a mechanism to change the parameters of the unavailability service period (SP) or P2P TWT SPs. This is illustrated in FIG. 9.

Once a first STA has established a P2P TWT schedule with its associated AP, it is possible that the first STA is still available during a first set of P2P TWT SPs, while not available during a second set of P2P TWT SPs, where both the first and the second sets of the P2P TWT SPs correspond to the same first P2P TWT schedule that the first STA has established with the AP.

Multi-link operation is a critical aspect of a WLAN network. How the P2P TWT schedule would work with multi-link operation is not clear at present.

Accordingly, embodiments of the present disclosure provide a mechanism and framework for handling multi-link operation for P2P TWT operation.

FIG. 10 illustrates an example of link indication for unavailability schedule establishment where the response frame does not contain the link information 1000 according to embodiments of the present disclosure. The embodiment of an example of link indication for unavailability schedule establishment where the response frame does not contain the link information 1000 shown in FIG. 10 is for illustration only. Other embodiments of an example of link indication for unavailability schedule establishment where the response frame does not contain the link information 1000 could be used without departing from the scope of this disclosure.

According to one embodiment, a non-AP MLD may send a request to its associated AP MLD to establish a P2P schedule over a particular link. A first non-AP STA affiliated with the non-AP MLD and operating on the first link may send a request frame to the corresponding first AP affiliated with the AP MLD and operating on the first link requesting to establish a P2P TWT schedule and indicate a link over which the schedule is to be established. According to one embodiment, in order to indicate the request, the first non-AP STA may send a Channel Usage Request frame to the first AP; in response, the first AP can send a Channel Usage Response frame to the first non-AP STA. According to one embodiment, the first non-AP STA in the Channel Usage Request frame may include a field containing the link information along with the TWT element corresponding to the P2P TWT schedule.

According to one embodiment, the first AP, upon receiving the request frame, may send a response frame to the first non-AP STA, where the response frame may indicate whether the AP MLD has accepted or rejected the request or suggest alternative set of parameters for the P2P TWT schedule. If the AP MLD has accepted the request, then the first AP may indicate ACCEPT in the channel usage response frame and may or may not include any TWT element or link information related field or element. This is illustrated in FIG. 10.

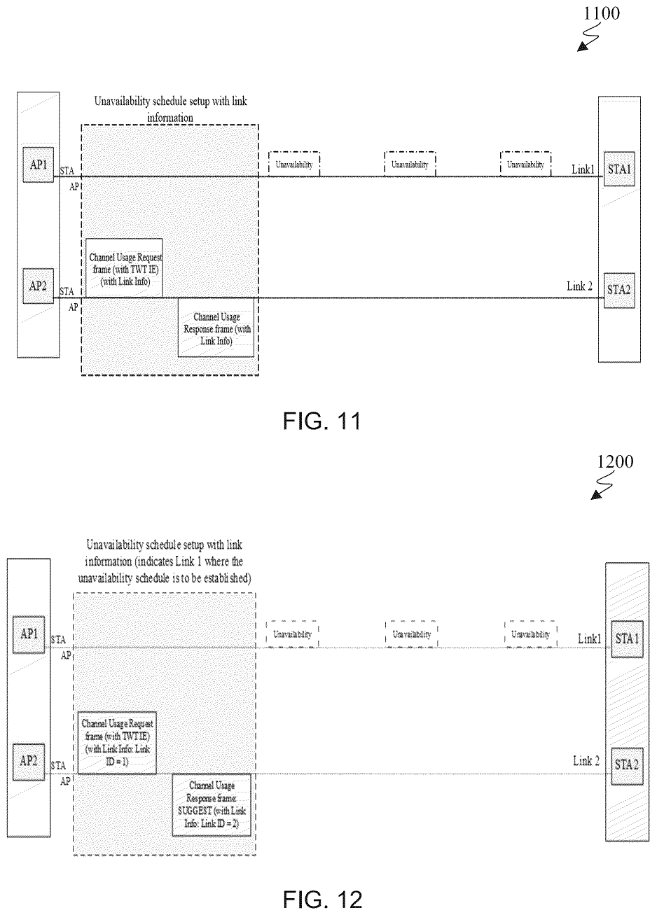

FIG. 11 illustrates an example of link indication for unavailability schedule establishment where the response frame contains the link information 1100 according to embodiments of the present disclosure. The embodiment of an example of link indication for unavailability schedule establishment where the response frame contains the link information 1100 shown in FIG. 11 is for illustration only. Other embodiments of an example of link indication for unavailability schedule establishment where the response frame contains the link information 1100 could be used without departing from the scope of this disclosure.

In reference to the previous embodiment, if the AP MLD does not accept the request from the non-AP MLD to establish a P2P TWT on a particular link that the non-AP MLD has indicated, the AP MLD may suggest an alternative link over which the P2P TWT schedule may be established. In such a scenario, the AP MLD may also include a field containing information the indicates the link over which the TWT schedule is suggested to be established. This is illustrated in FIG. 11.

FIG. 12 illustrates an example of an AP MLD suggesting an alternative link for establishing the P2P TWT schedule 1200 according to embodiments of the present disclosure. The embodiment of an example of an AP MLD suggesting an alternative link for establishing the P2P TWT schedule 1200 shown in FIG. 12 is for illustration only. Other embodiments of an example of an AP MLD suggesting an alternative link for establishing the P2P TWT schedule 1200 could be used without departing from the scope of this disclosure.

According to one embodiment, the link information carried in the request or response frame can be in the form of a Link ID which can be a 3 bit or 4 bit field indicating the numerical value of the link number established between the AP MLD and the non-AP MLD over which the P2P TWT is suggested to be established. According to another embodiment, the link information can be in the form of a bitmap; a 1 in a bit position in the bitmap may indicate that the P2P TWT is to be established on the corresponding link; otherwise, the P2P TWT is not be established in the corresponding link.

According to one embodiment, the link suggested by the AP MLD in the response frame can be different than the link requested by the non-AP MLD over which the P2P TWT is to be established (see FIG. 12). According to another embodiment, the link indicated by the AP MLD in the response frame can be the same as the link requested by the non-AP MLD over which the P2P TWT is to be established

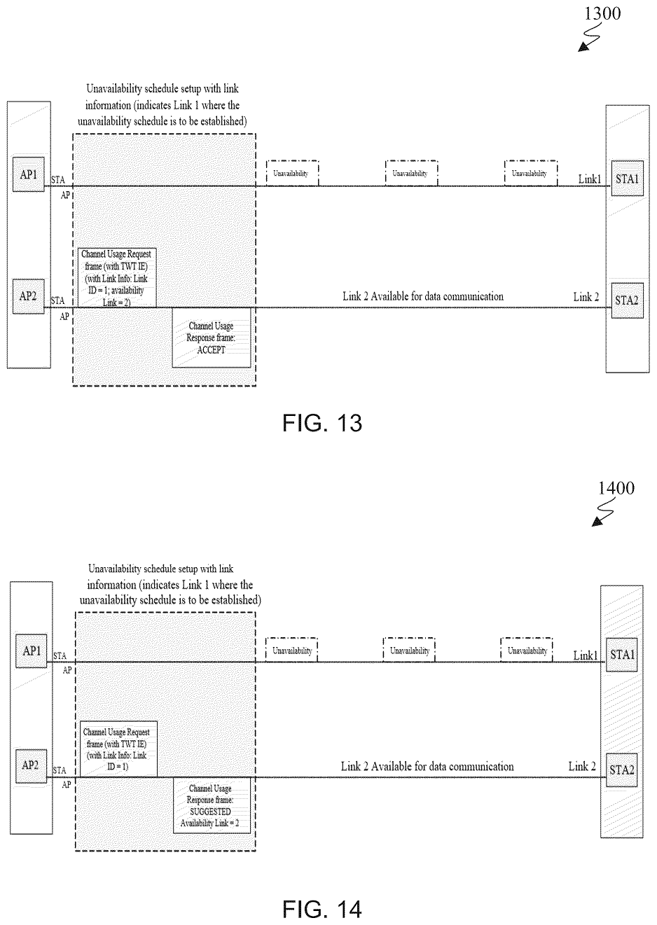

FIG. 13 illustrates an example of a non-AP MLD indicating an availability link for communication during the P2P TWT on another link 1300 according to embodiments of the present disclosure. The embodiment of an example of a non-AP MLD indicating an availability link for communication during the P2P TWT on another link 1300 shown in FIG. 13 is for illustration only. Other embodiments of an example of a non-AP MLD indicating an availability link for communication during the P2P TWT on another link 1300 could be used without departing from the scope of this disclosure.

According to one embodiment, for the scenario where a non-AP MLD sends a request to its associated AP MLD requesting to establish a P2P TWT over a first link, the non-AP MLD may also indicate that the non-AP MLD would be available on a second link for data communication with the AP MLD. In such a case, the non-AP MLD may include a field containing information on the availability link. This is illustrated in FIG. 13.

FIG. 14 illustrates an AP MLD suggesting an availability link in the response frame 1400 according to embodiments of the present disclosure. The embodiment of an AP MLD suggesting an availability link in the response frame 1400 shown in FIG. 14 is for illustration only. Other embodiments of an AP MLD suggesting an availability link in the response frame 1400 could be used without departing from the scope of this disclosure.

According to one embodiment, for the scenario where a non-AP MLD sends a request to its associated AP MLD requesting to establish a P2P TWT over a first link, the non-AP MLD, in the response frame it transmits to the non-AP MLD, may suggested a second link over which the AP MLD requests the non-AP MLD to be available for smooth data communication between the AP MLD and the non-AP MLD. In such a case, the non-AP MLD may include a field containing information on the availability link. This is illustrated in FIG. 14.

The information on the availability link can be in the form of a Link ID or in the form of a link bitmap

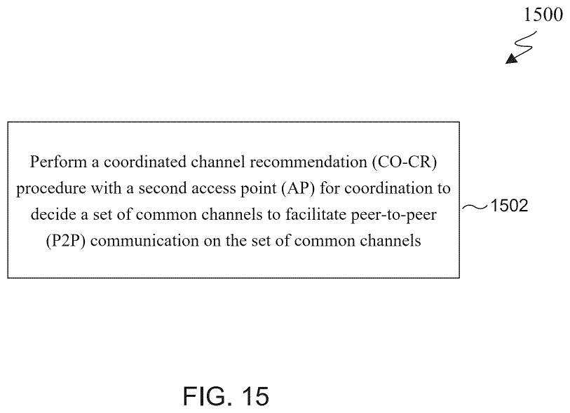

FIG. 15 illustrates an example method 1500 performed by an AP in a wireless communication system according to embodiments of the present disclosure. The method 1500 of FIG. 15 can be performed by any of the APs 101-103 of FIG. 1, such as AP 101 of FIG. 2. The method 1500 is for illustration only and other embodiments can be used without departing from the scope of the present disclosure.

As illustrated in FIG. 15, the method 1500 begins at step 1502, where a first AP performs a coordinated channel recommendation (CO-CR) procedure with a second AP for coordination to decide a set of common channels to facilitate peer-to-peer (P2P) communication on the set of common channels.

In some embodiments, the first AP advertises the set of common channels by including common channel information in a beacon frame, a probe response frame, or an association response frame.

In some embodiments, the first AP includes the common channel information in a channel usage element, and includes the channel usage element in the beacon frame, the probe response frame, or the association response frame.

In some embodiments, the first AP sends a first message to the second AP that includes information indicating that the first message is a request for negotiating, between the first AP and the second AP, the set of common channels for advertisement in both a first basic service set (BSS) controlled/managed by the first AP and in a second BSS controlled/managed by the second AP, where the first message includes information indicating parameters for the set of common channels.

In some embodiments, the first message includes a field having a value that indicates a suggestion of parameters for the set of common channels.

In some embodiments, the first AP receives a second message from the second AP indicating whether the second AP agrees to the parameters for the set of common channels.

In some embodiments, the second message includes a field indicating whether the second AP agrees to the parameters for the set of common channels.

In some embodiments, a value in the field of the second message indicates acceptance of the parameters for the set of common channels, rejection of the parameters for the set of common channels, or an alternate suggestion of parameters for the set of common channels.

In some embodiments, the second message indicates acceptance of the parameters for the set of common channels by the second AP; and the first AP derives the set of common channels that is agreed to by the first AP and the second AP; advertises the set of common channels in the first BSS; and indicates in the advertisement that the set of common channels facilitates P2P communication.

In some embodiments, the second message indicates an alternate suggestion of parameters for the set of common channels by the second AP; and the first AP derives the set of common channels based on the alternate suggestion of parameters for the set of common channels by the second AP; sends a third message to the second AP to request for coordination on deciding a set of common channels for P2P communication, where the third message includes the parameters suggested by the second AP, derived from the second message received from the second AP; receives a fourth message from the second AP that indicates that the second AP agrees to the parameters for the set of common channels indicated in the third message; advertises the set of common channels in the first BSS; and indicates in the advertisement that the set of common channels facilitates P2P communication.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

1Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A first access point (AP) comprising:
a transceiver; and
a processor operably coupled to the transceiver, the processor configured to perform a coordinated channel recommendation (CO-CR) procedure with a second AP for coordination to decide a set of common channels to facilitate peer-to-peer (P2P) communication on the set of common channels.

2. The first AP of claim 1, wherein to perform the CO-CR procedure, the processor is further configured to advertise the set of common channels by including common channel information in a beacon frame, a probe response frame, or an association response frame.

3. The first AP of claim 2, wherein the processor is further configured to:
include the common channel information in a channel usage element; and
include the channel usage element in the beacon frame, the probe response frame, or the association response frame.

4. The first AP of claim 1, wherein:
to perform the CO-CR procedure, the processor is further configured to send a first message to the second AP that includes information indicating that the first message is a request for negotiating, between the first AP and the second AP, the set of common channels for advertisement in both a first basic service set (BSS) controlled/managed by the first AP and in a second BSS controlled/managed by the second AP, and
the first message includes information indicating parameters for the set of common channels.

5. The first AP of claim 4, wherein the first message includes a field having a value that indicates a suggestion of parameters for the set of common channels.

6. The first AP of claim 4, wherein to perform the CO-CR procedure, the processor is further configured to receive a second message from the second AP indicating whether the second AP agrees to the parameters for the set of common channels.

7. The first AP of claim 6, wherein the second message includes a field indicating whether the second AP agrees to the parameters for the set of common channels.

8. The first AP of claim 7, wherein a value in the field of the second message indicates acceptance of the parameters for the set of common channels, rejection of the parameters for the set of common channels, or an alternate suggestion of parameters for the set of common channels.

9. The first AP of claim 6, wherein:
the second message indicates acceptance of the parameters for the set of common channels by the second AP; and
the processor is further configured to:
derive the set of common channels that is agreed to by the first AP and the second AP;
advertise the set of common channels in the first BSS; and
indicate in the advertisement that the set of common channels facilitates P2P communication.

10. The first AP of claim 6, wherein:
the second message indicates an alternate suggestion of parameters for the set of common channels by the second AP; and
the processor is further configured to:
derive the set of common channels based on the alternate suggestion of parameters for the set of common channels by the second AP;
send a third message to the second AP to request for coordination on deciding a set of common channels for P2P communication, where the third message includes the parameters suggested by the second AP, derived from the second message received from the second AP;
receive a fourth message from the second AP that indicates that the second AP agrees to the parameters for the set of common channels indicated in the third message;
advertise the set of common channels in the first BSS; and
indicate in the advertisement that the set of common channels facilitates P2P communication.

11. A method performed by a first access point (AP), the method comprising performing a coordinated channel recommendation (CO-CR) procedure with a second AP for coordination to decide a set of common channels to facilitate peer-to-peer (P2P) communication on the set of common channels.

12. The method of claim 11, further comprising advertising the set of common channels by including common channel information in a beacon frame, a probe response frame, or an association response frame.

13. The method of claim 12, further comprising:
including the common channel information in a channel usage element; and
including the channel usage element in the beacon frame, the probe response frame, or the association response frame.

14. The method of claim 11, further comprising:
sending a first message to the second AP that includes information indicating that the first message is a request for negotiating, between the first AP and the second AP, the set of common channels for advertisement in both a first basic service set (BSS) controlled/managed by the first AP and in a second BSS controlled/managed by the second AP,
wherein the first message includes information indicating parameters for the set of common channels.

15. The method of claim 14, wherein the first message includes a field having a value that indicates a suggestion of parameters for the set of common channels.

16. The method of claim 14, further comprising receiving a second message from the second AP indicating whether the second AP agrees to the parameters for the set of common channels.

17. The method of claim 16, wherein the second message includes a field indicating whether the second AP agrees to the parameters for the set of common channels.

18. The method of claim 17, wherein a value in the field of the second message indicates acceptance of the parameters for the set of common channels, rejection of the parameters for the set of common channels, or an alternate suggestion of parameters for the set of common channels.

19. The method of claim 16, wherein:
the second message indicates acceptance of the parameters for the set of common channels by the second AP; and
the method further comprises:
deriving the set of common channels that is agreed to by the first AP and the second AP;
advertising the set of common channels in the first BSS; and
indicating in the advertisement that the set of common channels facilitates P2P communication.

20. The method of claim 16, wherein:
the second message indicates an alternate suggestion of parameters for the set of common channels by the second AP; and
the method further comprises:
deriving the set of common channels based on the alternate suggestion of parameters for the set of common channels by the second AP;
sending a third message to the second AP to request for coordination on deciding a set of common channels for P2P communication, where the third message includes the parameters suggested by the second AP, derived from the second message received from the second AP;
receiving a fourth message from the second AP that indicates that the second AP agrees to the parameters for the set of common channels indicated in the third message;
advertising the set of common channels in the first BSS; and
indicating in the advertisement that the set of common channels facilitates P2P communication.
